(19) United States
(12) Patent Application Publication
(10) Pub. No.: US 2013/0170543 A1
(43) Pub. Date: Jul. 4, 2013

(54) SYSTEMS, METHODS, AND COMPUTER PROGRAM PRODUCTS FOR STREAMING OUT OF DATA FOR VIDEO TRANSCODING AND OTHER APPLICATIONS

(71) Applicants: Ning Lu, Saratoga, CA (US); Hong H. Jiang, El Dorado Hills, CA (US)

(72) Inventors: Ning Lu, Saratoga, CA (US); Hong H. Jiang, El Dorado Hills, CA (US)

(21) Appl. No.: 13/341,444

(22) Filed: Dec. 30, 2011

(51) Int. Cl. H04N 7/26; H04N 7/32

(52) U.S. Cl. 375/240.03; 375/240.25; 375/240.16; 375/240.24; 375/E07.027; 375/E07.126; 375/E07.243

(57) ABSTRACT

Methods, systems, and computer program products that use descriptive information in a coded video stream to accelerate the transcoding process. This information, including information that is sometimes known as syntax information, may reside explicitly in headers of a coded stream. Examples of such information may include motion vectors, macroblock types, intra block prediction modes, inter block descriptive information, and quantization parameters. Other descriptive information may be derived from the actual coded macroblocks, e.g., the number of bits used to encode a macroblock, or the number of non-zero coefficients used in encoding, or the coefficients themselves. Such descriptive information may be used directly in the encoding phase of the transcoding process to improve the speed and throughput of the transcoding. Such descriptive information may also be used to enhance other video processing applications, such as scene change detection, determining object segmentation, or motion censoring.

### BACKGROUND

The transcoding of video generally entails the decoding of a video signal that is in one format, then taking the resulting pixel data and encoding this data in a second format. Video necessarily represents a considerable amount of binary data, even after having been compressed by a coding scheme. Moreover, depending on the compression schemes of the two formats, the amount of processing in a transcoding system may be extensive. As a result of these factors, transcoding may be a slow process.

In some contexts, the speed at which transcoding takes place may not be an issue. In other contexts, however, speed may be important. A user may want or need to have video delivered in real time, or as close to real time as possible. This may be the case in media consumption situations, in multi-player gaming scenarios, or in any situation where video information has to be available in a timely manner. In situations like these, any stage of video processing that requires significant execution time may be problematic.

### BRIEF DESCRIPTION OF THE DRAWINGS/FIGURES

FIG. 1 is a block diagram of a transcoding process.

FIG. 2 is an exemplary block diagram of a transcoding system.

FIG. 3 illustrates an exemplary format for an encoded video stream.

FIG. 4 is a flowchart illustrating a transcoding process, according to an embodiment.

FIG. 5 is a block diagram of a transcoding system, according to an embodiment.

FIG. 6 is a flowchart illustrating the extraction of data from an encoded video stream and the use of this data in video processing applications, according to an embodiment.

FIG. 7 illustrates a computing context for a software embodiment.

FIG. 8 is a block diagram illustrating a system in which the system and processing described above may be implemented, according to an embodiment.

FIG. 9 illustrates a device in which the system and processing described above may be implemented, according to an embodiment.

In the drawings, the leftmost digit(s) of a reference number identifies the drawing in which the reference number first appears.

### DETAILED DESCRIPTION

An embodiment is now described with reference to the figures, where like reference numbers indicate identical or functionally similar elements. While specific configurations and arrangements are discussed, it should be understood that this is done for illustrative purposes only. A person skilled in the relevant art will recognize that other configurations and arrangements can be used without departing from the spirit and scope of the description. It will be apparent to a person skilled in the relevant art that this can also be employed in a variety of other systems and applications other than what is described herein.

Disclosed herein are methods, systems, and computer program products that use descriptive information in a coded video stream to accelerate the transcoding process. This information, including information that is sometimes known as syntax information, may reside explicitly in headers of a coded stream. Examples of such information may include motion vectors, macroblock types, intra block prediction modes, inter block descriptive information, and quantization parameters. Other descriptive information may be derived from the actual coded macroblocks, e.g., the number of bits used to encode a macroblock, or the number of non-zero coefficients used in a transform process in the encoding, or the coefficients themselves. Such descriptive information may be extracted or otherwise streamed out and used directly in the encoding phase of the transcoding process to improve the speed and throughput of the transcoding. Such descriptive information may also be used to enhance other applications, such as scene change detection, determination of object segmentation, or motion censoring.

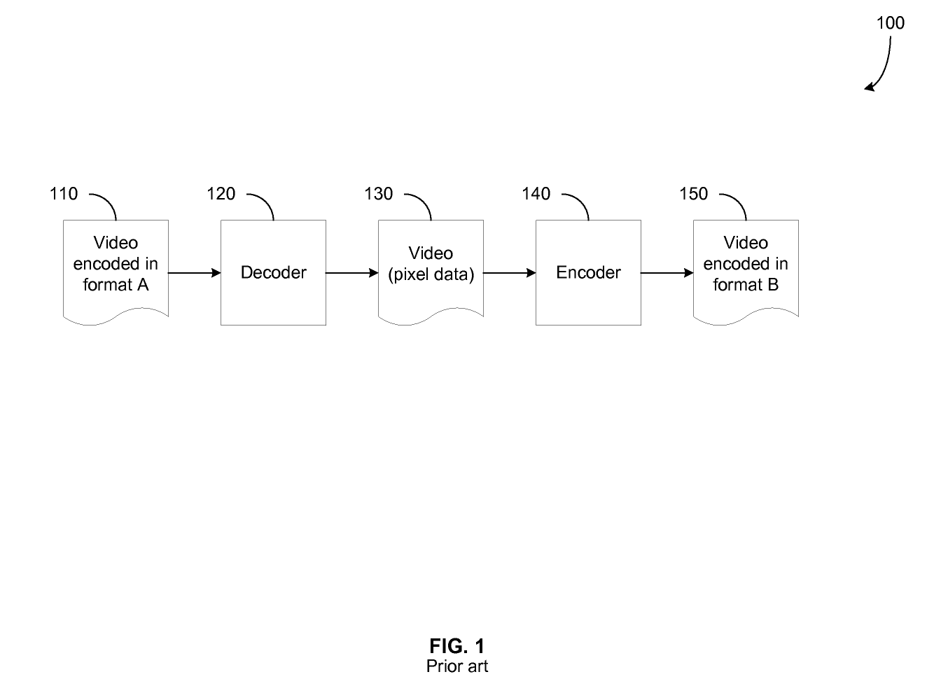

A transcoding process is illustrated generally in FIG. 1. Transcoding may receive video data that has been encoded in a certain format, decode the video data into pixel data, and re-encode the pixel data according to a second coding format. In this illustration, video encoded in a format A is shown as video data 110. This data may be received at a decoder 120, which may decode the data into video in pixel form (pixel data 130). This latter pixel data 130 may then be re-encoded in a format B by encoder 140, producing encoded video data 150.

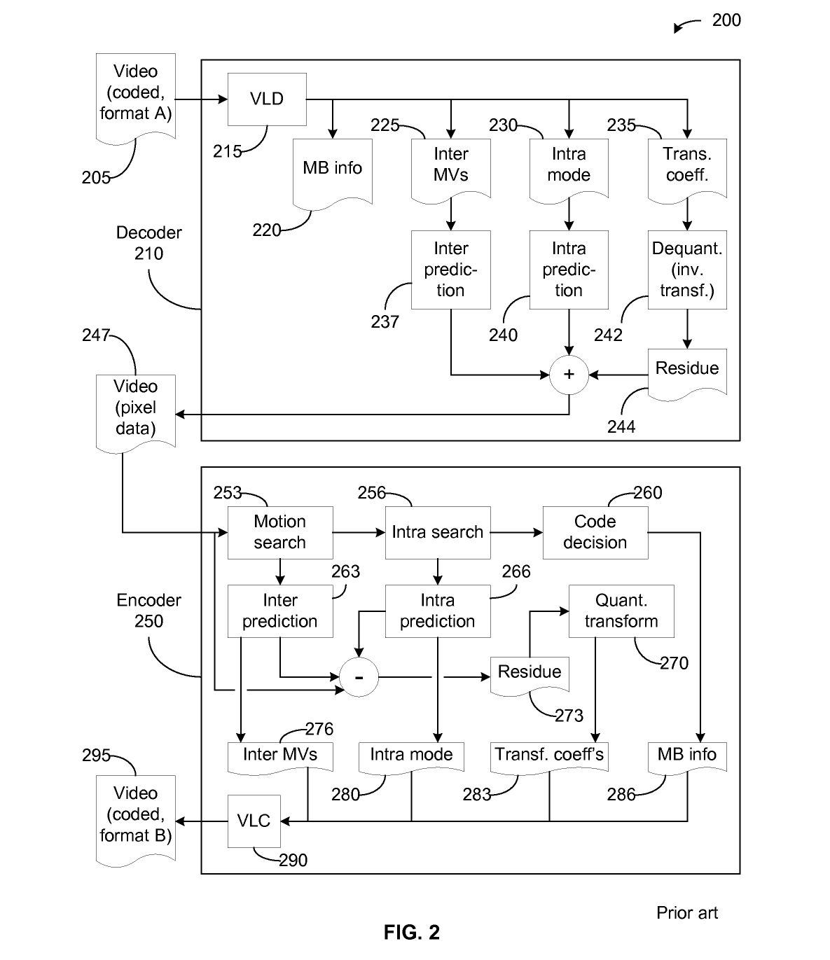

A block diagram illustrating such a video transcoding process is provided as FIG. 2. Video data encoded in a format A is shown as data 205. This data may be received at a decoder 210. The encoded video data 205 may be input to a variable length decoding (VLD) module 215. Several pieces of information may then be obtained, including macroblock (MB) information 220 (e.g., the type of a macroblock), inter frame motion vectors (MVs) 225 or intra frame prediction mode 230 (depending on frame type), and one or more transform coefficients 235. The inter frame MVs 225 may be input to an inter frame prediction module 237, to generate a motion prediction based on the MVs 225. The intra frame prediction mode 230 may be input to an intra frame prediction module 240 to generate motion information. The transform coefficients 235 may be input into a dequantization module 242, which may perform an inverse transform of the coded video. The dequantization module 242 may output residue data 244. The residue 244 may be combined with the results from the inter frame prediction module 237 or the intra frame prediction module 240 (depending on frame type), resulting in pixel data 247.

The pixel data 247 may then be input into an encoder 250. Pixel data 247 may first be input to a motion search module 253; the resulting search results may be sent to an inter frame prediction module 263 to generate inter frame MVs 276. Pixel data 247 may be sent to intra frame search module 256, to generate an intra frame motion mode 280. The pixel data 247 may also be sent to a code decision module 260 to generate macroblock information 286, such as a macroblock type identifier. The pixel data 247 may be differenced with the outputs of the inter frame prediction module 263 or that of the intra frame prediction module 266, resulting in residue data 273. The residue 273 may be sent to a quantization transform module 270, which may then generate transform coefficients 283. Code decision module 260 may output MB information 286, e.g., a macroblock type. The MB information 286, the coefficients 283, and the intra mode 280 or the motion vectors 276 (depending on frame type) may then be input to a variable length coding module (VLC) 290, which may produce video data 295 encoded in a second format (shown here as format B).

In the system, methods, and computer program products described herein, descriptive information in a coded video stream may be used to accelerate the transcoding process and/or facilitate other video processing applications. Some of this descriptive information may be found in the header of the coded video stream. Examples of such descriptive information may include motion vectors and MB type information. Other descriptive information may not be found explicitly in a header, but rather may be determined properties of the payload of the stream, i.e., properties of the encoded blocks. Such payload properties may include number of non-zero transformation coefficients, the value of such coefficients, and/or the number of bits used in coding an MB.

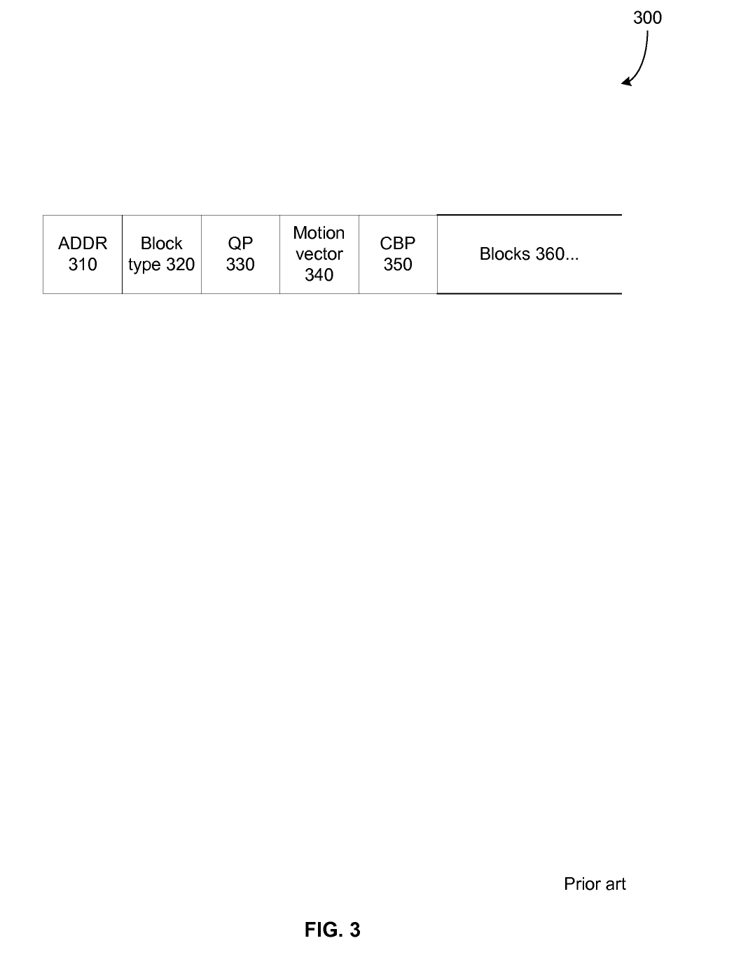

An example of the general structure of a coded video stream is shown in FIG. 3. Here, the header may include an address 310, where this address may represent the address of a macroblock in an image. The header may also include a type 320, where this may refer to the type of a block or macroblock, e.g., intra frame, inter frame, bi-directional inter frame, or skip. The header may also include a quantization parameter (QP) 330 for quantifying residue data, and a definition of one or more motion vectors 340, one for each sub-block in the case of an inter frame. The header may also include a coded block pattern (CBP) 350. In this example, the payload may consist of one or more coded blocks 360, e.g., macroblocks. In other examples, a header may also specify the intra frame prediction mode (in the case of an intra frame), or provide information relating to inter frames in the event that such frames are present. The latter information may include the prediction mode (forward or backward), information about partitioning, and/or a reference frame index.

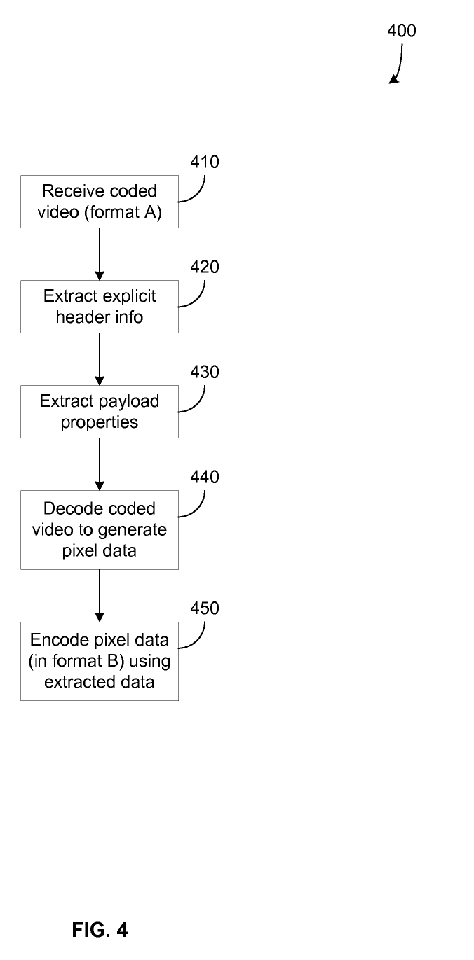

FIG. 4 illustrates processing of the systems, methods, and computer program products described herein, according to an embodiment. At 410, coded video may be received, where the video is coded according to a first format (identified as format A). At 420, descriptive information may be extracted from the header of the coded video, where this information is descriptive of how the video is encoded. This explicit information may include the type of the macroblock(s), a quantization parameter, and/or motion vector(s), for example.

At 430, additional descriptive information may be extracted from the macroblocks of the encoded video (i.e., from the payload of the encoded video), where this additional descriptive information may represent properties of the encoded video. These properties may include the values of non-zero coefficients used in the coding transform or the number of such coefficients. These properties may also include the number of bits used to encode the macroblock(s).

At 440, the coded video may be decoded to generate pixel data. Note that while 440, 430, and 420 are shown as serial stages in FIG. 4, in alternative embodiments some or all of these may be performed in parallel to various extents.

At 450, the pixel data may be encoded in a second format, shown as format B, using the extracted header information and payload properties as will be described in greater detail below.

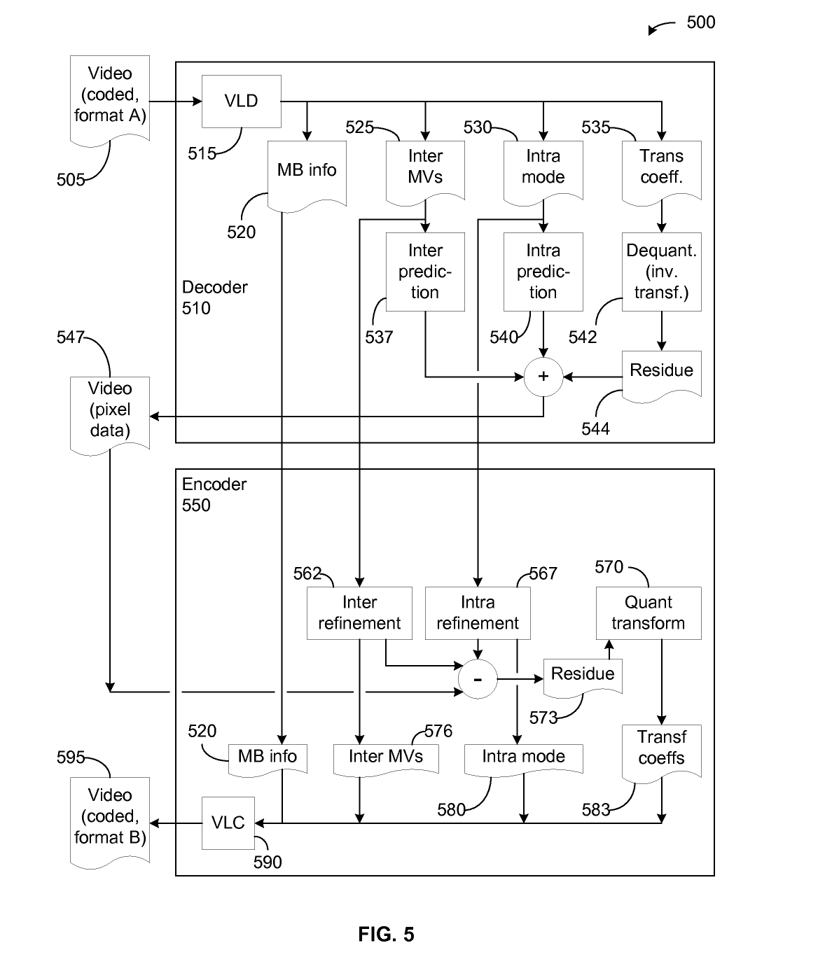

FIG. 5 illustrates how some of the extracted information from a coded video stream may be used to speed up a transcoding process, according to an embodiment. Video data encoded in a format A is shown as data 505. This data may be received at a decoder 510. The encoded video data 505 may be input to a variable length decoding (VLD) module 515. Several pieces of information may be obtained, including macroblock (MB) information 520 (e.g., the type of a macroblock) and inter frame motion vectors (MVs) 525 or intra frame prediction mode 530 (depending on the frame type). These three pieces of information may be extracted from the header(s) of video data 505 in an embodiment. Transform coefficients 535 may also be extracted, including the non-zero coefficients. In an embodiment, coefficients 535 may be obtained by examination of the coded blocks themselves, rather than by examination of the header.

The inter frame MVs 525 may be input to an inter frame prediction module 537 to generate motion predictions based on MVs 525. The intra frame prediction mode 530 may be input to an intra frame prediction module 540 to generate an intra frame motion prediction. The transform coefficients 535 may be input into a dequantization module 542, which may perform an inverse transform of the coded video. The dequantization module 542 may output residue 544. The residue 544 may be combined with results from the inter frame prediction module 537 or the intra frame prediction module 540 (depending on frame type), resulting in pixel data 547.

The pixel data 547 may then be passed to an encoder 550, along with MB information 520 and inter frame MVs 525 or intra frame prediction mode 530 (depending on frame type). The inter frame MVs 525 may be input to an inter refinement module 562 in the case of inter frames, and the intra frame prediction mode 530 may be input to an intra refinement module 567 in the case of intra frames. The inter refinement module 562 may be responsible for the refinement or adjustment of inter MVs 525, given that the MVs 525 may be close to what is needed for the new format of encoder 550, but not precisely appropriate for encoding in this format. The intra refinement module 567 may be responsible for refinement of the intra mode 530. Similarly, this refinement may be necessary given the different requirements of the encoding format of encoder 550. The refined inter frame MVs 567 or refined intra frame prediction mode 580 (depending on frame type), along with pixel data 547, may be input to a difference operation, resulting in residue 573. The residue 573 may be input to a quantization transform module 570, which consequently produces transform coefficients 583. The coefficients 583, along with the refined inter frame MVs 576 or the refined intra frame prediction mode 580 (depending on frame type), and the MB information 520 may be used by a variable length coding module 590 to produce video 595 coded in a second format (shown here as format B).

Note that the system and processing of the embodiment of FIG. 5 may require less motion estimation in the encoder 550, or none at all. This is made possible because the MVs 525 extracted in decoder 510 may be re-used during encoding, simplifying or eliminating motion estimation. Moreover, compression bias and artifacts may be eliminated if the original MVs 525 better reflect true motion. In alternative embodiments, the exact MVs may not be used; instead, the MVs 525 may be used as guidance in encoder 550, so that motion searching may still take place, but over a limited search range defined at least in part by the MVs 525. In this case, there would still be speed and efficiency advantages, since less motion searching would be required in encoder 550. This refinement of the motion vectors may be implemented in inter refinement module 562 in the illustrated embodiment.

The intra frame prediction mode 530 may also be used to improve the transcoding process. Intra frame prediction mode 530 may provide information on surrounding macroblocks, information that may be refined by intra refinement module 567. Given this intra refinement process, intra mode search and prediction processes at the encoder may be eliminated or minimized at the encoder 550, making transcoding faster.

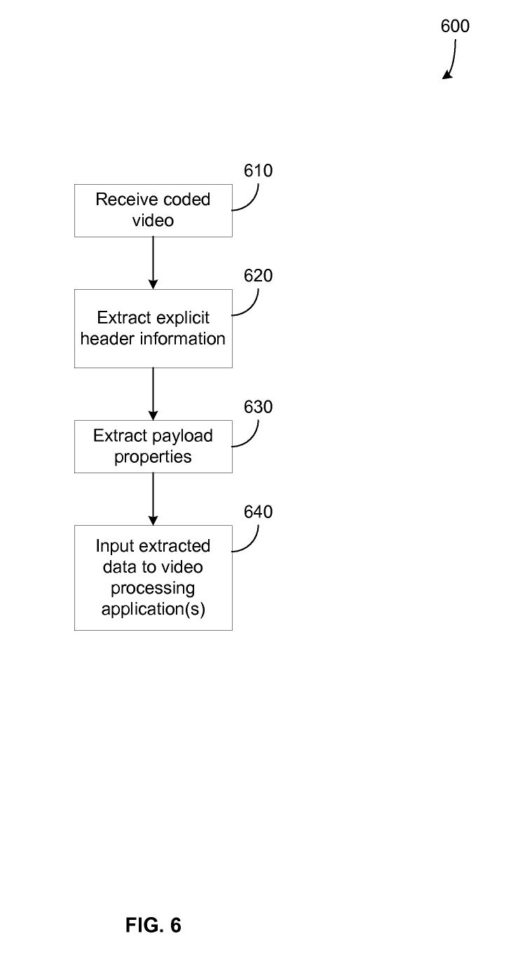

As noted above, data extracted from a coded video stream may be used for other video processing applications, apart from or in addition to transcoding. This is illustrated generally in FIG. 6, according to an embodiment. Here, coded video may be received at 610. At 620, descriptive information that may reside explicitly in a header may be extracted. This information may include, for example, the MB type, the intra frame prediction mode, and inter frame information (such as inter frame partitioning information, the forward or backward partitioning mode, and/or a reference frame index). At 630, properties of the payload (i.e., properties of the macroblocks of the coded video) may be extracted. These properties may include, for example, the number of bits used to encode a macroblock, the values of non-zero transform coefficients, or the number of such coefficients. At 630, the extracted data from 620 and/or 630 may be used in one or more video processing applications.

Examples of such applications may include a scene change detection application. If, for example, the MB type changes or there is a change in a pattern or trend of motion vectors, this would suggest a scene change. Descriptive information and changes thereto may therefore be valuable in detection of a scene change. MVs may be used for this purpose; in addition, changes in the number or value of non-zero transform coefficients may also reflect a scene change. Another example would be an object segmentation application, where regions of an object or scene may be classified. Such classification may be determined by changes in MVs, MB types, intra frame prediction modes, inter frame prediction modes, quantization parameters, or transform coefficients for example. Another example would be motion censoring, where censoring may be based on the identification of regions having inconsistent motions as determined, for example, by differences in motion vectors.

Various embodiments may be implemented using hardware elements, software elements, or a combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Examples of software may include software components such as application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints. The term software, as used herein, may refer to a computer program product including a computer readable medium having computer program logic stored therein to cause a computer system to perform one or more features and/or combinations of features disclosed herein. The computer readable medium may be transitory or non-transitory. An example of a transitory computer readable medium may be a digital signal transmitted over a radio frequency or over an electrical conductor, through a local or wide area network, or through a network such as the Internet. An example of a non-transitory computer readable medium may be a disk, a flash memory, RAM, ROM, or other data storage device.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

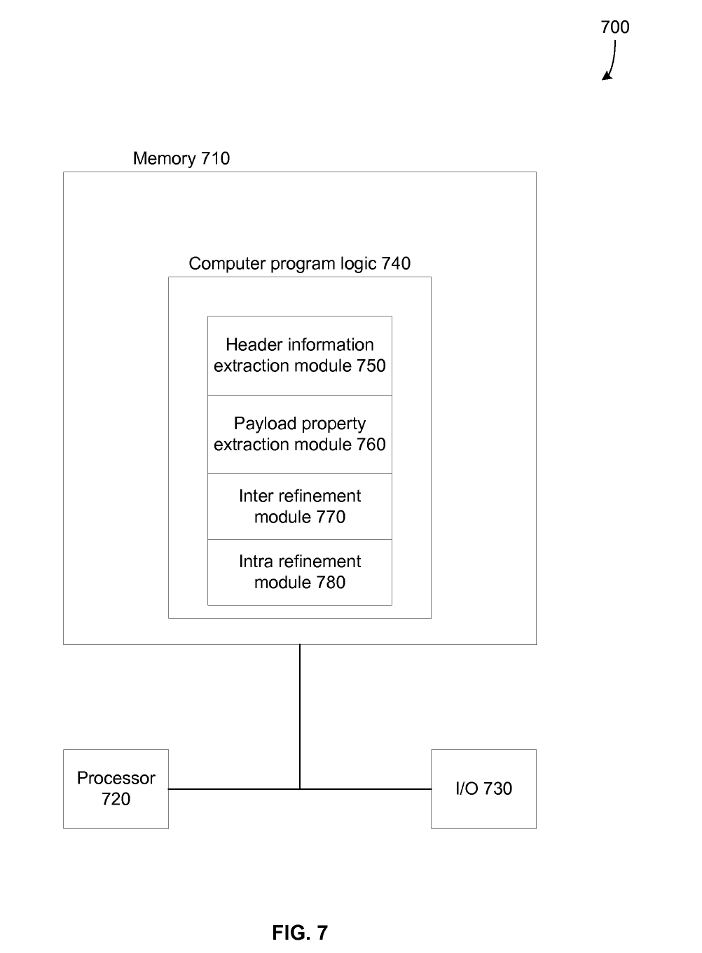

FIG. 7 illustrates a software embodiment of the processing described herein. System 700 may include a processor 720 and may further include a body of memory 710. Memory 710 may include one or more computer readable media that may store computer program logic 740. Memory 710 may be implemented as a hard disk and drive, a removable media such as a compact disk, a read-only memory (ROM) or random access memory (RAM) device, for example, or some combination thereof. Processor 720 and memory 710 may be in communication using any of several technologies known to one of ordinary skill in the art, such as a bus. Computer program logic 740 contained in memory 710 may be read and executed by processor 720. One or more I/O ports and/or I/O devices, shown collectively as I/O 730, may also be connected to processor 720 and memory 710.

Computer program logic 740 may include a header information extraction module 750, which may be responsible for reading information from the header(s) of a coded video stream, where this information may be used in a transcoding process and/or in other video processing applications. Computer program logic 740 may also include a payload property extraction module 760, which may be responsible for extracting properties of the encoded blocks themselves. As described above, such properties may be used in transcoding or in other video processing applications. Computer program logic 740 may also include an inter refinement module 770, which may be responsible for refinement or adjustment of inter frame MVs to meet the requirements of the re-encoding format. Computer program logic 740 may also include intra refinement module, which may be responsible for the refinement of intra frame prediction modes for use in the re-encoding process. In alternative embodiments, additional modules or fewer modules may be present than what is shown in FIG. 7.

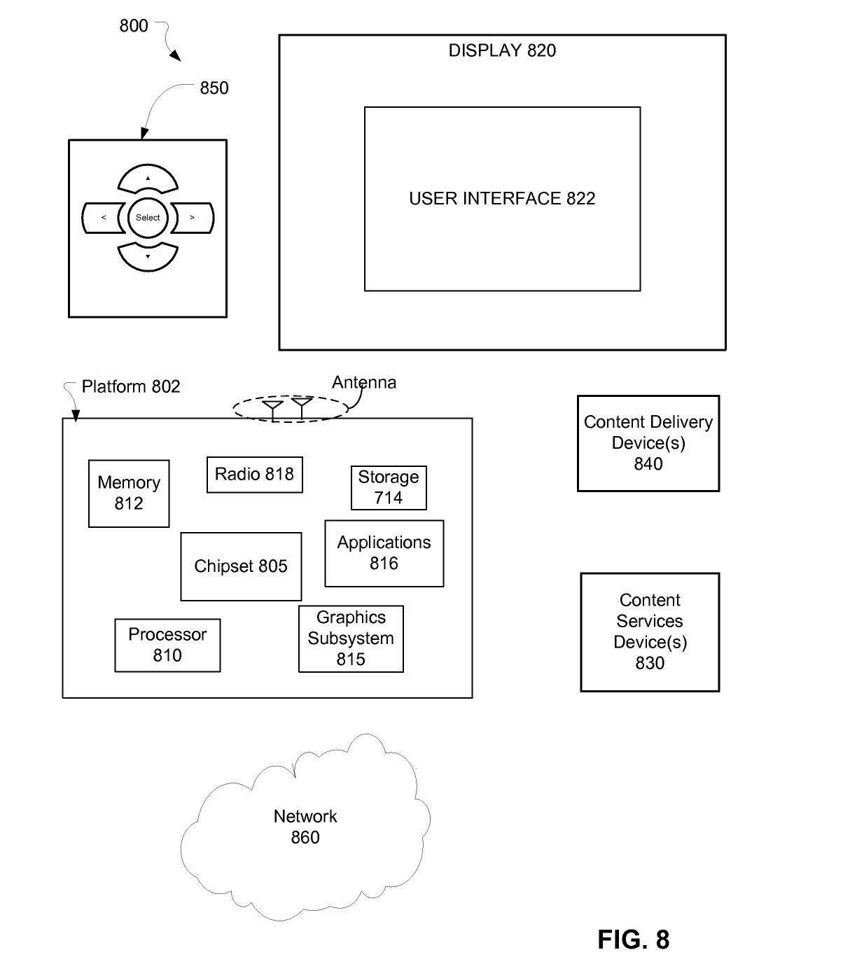

FIG. 8 illustrates an embodiment of a system 800 which may embody the system and processing described above. In embodiments, system 800 may be a media system although system 800 is not limited to this context. For example, system 800 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 800 comprises a platform 802 coupled to a display 720. Platform 802 may receive content from a content device such as content services device(s) 830 or content delivery device(s) 840 or other similar content sources. A navigation controller 850 comprising one or more navigation features may be used to interact with, for example, platform 802 and/or display 820. Each of these components is described in more detail below.

In embodiments, platform 802 may comprise any combination of a chipset 805, processor 810, memory 812, storage 814, graphics subsystem 815, applications 816 and/or radio 818. Chipset 805 may provide intercommunication among processor 810, memory 812, storage 814, graphics subsystem 815, applications 816 and/or radio 818. For example, chipset 805 may include a storage adapter (not depicted) capable of providing intercommunication with storage 814.

Processor 810 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 810 may comprise dual-core processor(s), dual-core mobile processor(s), and so forth.

Memory 812 may be implemented as a volatile memory device such as, but not limited to, a Random Access Memory (RAM), Dynamic Random Access Memory (DRAM), or Static RAM (SRAM).

Storage 814 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 814 may comprise technology to increase the storage performance enhanced protection for valuable digital media when multiple hard drives are included, for example.

Graphics subsystem 815 may perform processing of images such as still or video for display. Graphics subsystem 815 may include a graphics processing unit (GPU) or a visual processing unit (VPU), for example. An analog or digital interface may be used to communicatively couple graphics subsystem 815 and display 820. For example, the interface may be any of a High-Definition Multimedia Interface, DisplayPort, wireless HDMI, and/or wireless HD compliant techniques. Graphics subsystem 815 could be integrated into processor 810 or chipset 805. Graphics subsystem 815 could be a stand-alone card communicatively coupled to chipset 805. In an embodiment, the transcoding and other video processing applications described above may be implemented in graphics subsystem 815.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 818 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 818 may operate in accordance with one or more applicable standards in any version.

In embodiments, display 820 may comprise any television type monitor or display. Display 820 may comprise, for example, a computer display screen, touch screen display, video monitor, television-like device, and/or a television. Display 820 may be digital and/or analog. In embodiments, display 820 may be a holographic display. Also, display 820 may be a transparent surface that may receive a visual projection. Such projections may convey various forms of information, images, and/or objects. For example, such projections may be a visual overlay for a mobile augmented reality (MAR) application. Under the control of one or more software applications 816, platform 802 may display user interface 822 on display 820.

In embodiments, content services device(s) 830 may be hosted by any national, international and/or independent service and thus accessible to platform 802 via the Internet, for example. Content services device(s) 830 may be coupled to platform 802 and/or to display 820. Platform 802 and/or content services device(s) 830 may be coupled to a network 860 to communicate (e.g., send and/or receive) media information to and from network 860. Content delivery device(s) 840 also may be coupled to platform 802 and/or to display 820.

In embodiments, content services device(s) 830 may comprise a cable television box, personal computer, network, telephone, Internet enabled devices or appliance capable of delivering digital information and/or content, and any other similar device capable of unidirectionally or bidirectionally communicating content between content providers and platform 802 and/display 820, via network 860 or directly. It will be appreciated that the content may be communicated unidirectionally and/or bidirectionally to and from any one of the components in system 800 and a content provider via network 860. Examples of content may include any media information including, for example, video, music, medical and gaming information, and so forth.

Content services device(s) 830 receives content such as cable television programming including media information, digital information, and/or other content. Examples of content providers may include any cable or satellite television or radio or Internet content providers. The provided examples are not meant to limit embodiments of the invention.

In embodiments, platform 802 may receive control signals from navigation controller 850 having one or more navigation features. The navigation features of controller 850 may be used to interact with user interface 822, for example. In embodiments, navigation controller 850 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 850 may be echoed on a display (e.g., display 820) by movements of a pointer, cursor, focus ring, or other visual indicators displayed on the display. For example, under the control of software applications 816, the navigation features located on navigation controller 850 may be mapped to virtual navigation features displayed on user interface 822, for example. In embodiments, controller 850 may not be a separate component but integrated into platform 802 and/or display 820. Embodiments, however, are not limited to the elements or in the context shown or described herein.

In embodiments, drivers (not shown) may comprise technology to enable users to instantly turn on and off platform 802 like a television with the touch of a button after initial boot-up, when enabled, for example. Program logic may allow platform 802 to stream content to media adaptors or other content services device(s) 830 or content delivery device(s) 840 when the platform is turned “off” In addition, chip set 805 may comprise hardware and/or software support for surround sound audio and/or high definition surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 800 may be integrated. For example, platform 802 and content services device(s) 830 may be integrated, or platform 802 and content delivery device(s) 840 may be integrated, or platform 802, content services device(s) 830, and content delivery device(s) 840 may be integrated, for example. In various embodiments, platform 802 and display 820 may be an integrated unit. Display 820 and content service device(s) 830 may be integrated, or display 820 and content delivery device(s) 840 may be integrated, for example. These examples are not meant to limit the invention.

In various embodiments, system 800 may be implemented as a wireless system, a wired system, or a combination of both. When implemented as a wireless system, system 800 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 800 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 802 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 8.

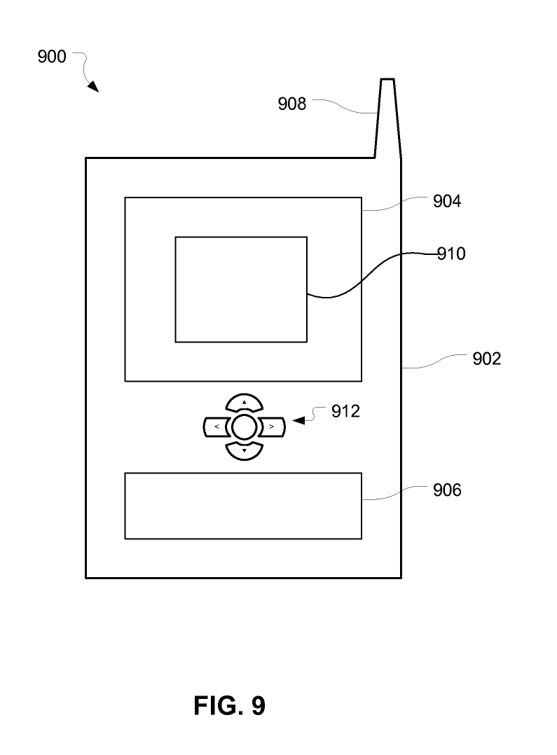

As described above, system 800 may be embodied in varying physical styles or form factors. FIG. 9 illustrates embodiments of a small form factor device 900 in which system 800 may be embodied. In embodiments, for example, device 900 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 9, device 900 may comprise a housing 902, a display 904, an input/output (I/O) device 906, and an antenna 908. Device 900 also may comprise navigation features 912. Display 904 may comprise any suitable display unit for displaying information appropriate for a mobile computing device. I/O device 906 may comprise any suitable I/O device for entering information into a mobile computing device. Examples for I/O device 906 may include an alphanumeric keyboard, a numeric keypad, a touch pad, input keys, buttons, switches, rocker switches, microphones, speakers, voice recognition device and software, and so forth. Information also may be entered into device 900 by way of microphone. Such information may be digitized by a voice recognition device. The embodiments are not limited in this context.

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the exemplary embodiments disclosed herein.

What is claimed is:

1. A method, comprising:
receiving a coded video stream at a decoder;
extracting header information from the coded video stream; and
applying the header information in an encoding process at an encoder.

2. The method of claim 1, wherein the header information comprises one or more of:
macroblock type information;
information identifying an intra frame prediction mode; and
a motion vector.

3. The method of claim 1, further comprising:
extracting one or more payload properties from the coded video stream; and
applying the payload properties in the encoding process.

4. The method of claim 3, wherein the payload properties comprise one or more of:
values of non-zero coefficients; and
a number of non-zero coefficients.

5. The method of claim 3, wherein the payload properties comprise the number of bits used to encode a macroblock.

6. The method of claim 3, wherein one or more of the header information and the payload properties are applied to one or more video processing applications.

7. The method of claim 6, wherein the video processing applications comprise one or more of:
a scene change detection application;
an object segmentation application; and
a motion censoring application.

8. The method of claim 6, wherein the header information comprises one or more of:
interblocking partitioning information;
a forward or backward prediction mode; and
a reference frame index.

9. The method of claim 6, wherein the header information comprises one or more of:
a quantization parameter; and
a quantization matrix.

10. A computer program product comprising a non-transitory computer useable medium having control logic stored therein, the computer control logic comprising logic to cause a processor to:
receive a coded video stream at a decoder;
extract header information from the coded video stream; and
apply the header information in an encoding process at an encoder.

11. The computer program product of claim 10, wherein the header information comprises one or more of:
macroblock type information;
information identifying an intra frame prediction mode; and
a motion vector.

12. The computer program product of claim 10, the computer control logic further comprising logic to cause the processor to:
extract one or more payload properties from the coded video stream; and
apply the payload properties in the encoding process.

13. The computer program product of claim 12, wherein the payload properties comprise one or more of:
values of non-zero coefficients; and
a number of non-zero coefficients.

14. The computer program product of claim 12, wherein the payload properties comprise the number of bits used to encode a macroblock.

15. The computer program product of claim 12, wherein one or more of the header information and the payload properties are applied to one or more video processing applications.

16. The computer program product of claim 15, wherein the video processing applications comprise one or more of:
a scene change detection application;
an object segmentation application; and
a motion censoring application.

17. The computer program product of claim 15, wherein the header information comprises one or more of:
interblocking partitioning information;
a forward or backward prediction mode; and
a reference frame index.

18. The computer program product of claim 15, wherein the header information comprises one or more of:
a quantization parameter; and
a quantization matrix.

19. A system, comprising:
a processor; and
a memory in communication with said processor, said memory for storing a plurality of processing instructions configured to direct said processor to:
receive a coded video stream at a decoder;
extract header information from the coded video stream; and
apply the header information in an encoding process at an encoder.

20. The system of claim 19, wherein the header information comprises one or more of:
macroblock type information;
information identifying an intra frame prediction mode; and
a motion vector.

21. The system of claim 19, wherein said plurality of processing instructions is further configured to direct said processor to:
extract one or more payload properties from the coded video stream; and
apply the payload properties in the encoding process.

22. The system of claim 21, wherein the payload properties comprise one or more of:
values of non-zero coefficients; and
a number of non-zero coefficients.

23. The system of claim 21, wherein the payload properties comprise the number of bits used to encode a macroblock.

24. The system of claim 21, wherein one or more of the header information and the payload properties are applied to one or more video processing applications.

25. The system of claim 24, wherein the video processing applications comprise one or more of:
a scene change detection application;
an object segmentation application; and
a motion censoring application.

26. The system of claim 24, wherein the header information comprises one or more of:
interblocking partitioning information;
a forward or backward prediction mode; and
a reference frame index.

27. The system of claim 24, wherein the header information comprises one or more of:
a quantization parameter; and
a quantization matrix.
